(19) United States
(12) Patent Application Publication
(10) Pub. No.: US 2003/0229580 A1
(43) Pub. Date: Dec. 11, 2003

(54) Method for establishing or improving a credit score or rating for a business

(76) Inventors: David Gass, Las Vegas, NV (US); David Von Holten, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/167,947

(22) Filed: Jun. 10, 2002

(51) Int. Cl. G06F 17/60

(52) U.S. Cl. 705/38

(57) ABSTRACT

A method to establish or enhance a business credit score is disclosed. One embodiment describes a method of verifying the existence of business credit scores obtained from well known credit agencies/bureaus. In the absence of a credit score, a method is described to verify and eliminate any discrepancies related to the business' information in public records prior to engaging in the generation of a credit score. In establishing or improving a credit score, one embodiment describes a method of facilitating desirable payment transaction experiences with vendors capable of extending a line of credit to businesses without requiring any personal guarantee. In addition, these vendors are qualified to provide reliable reporting of payment experiences to the credit agencies/bureaus. One embodiment of the method facilitates receiving lines of credit, such as credit cards, from retail businesses not requiring a personal guarantee but which do require a credit rating.

### FIELD OF THE INVENTION

The present invention relates to a method of establishing or improving a business' credit score or rating.

### BACKGROUND OF THE INVENTION

Securing funding for one's business is important to its survival. The ability to provide the necessary funds to fuel the growth of a business, especially during the early stages, is fundamental to its success. While critical during start-up, sufficient cash flow requirements are also important in critical growth phases or expansion stages of a business. Preparing for these stages requires that a business secure funding for these future events. Expenses such as salaries, overhead, capital expenditures, selling, general and administrative, cost of goods sold, require that sufficient funds are available to accommodate these expenses.

It is often difficult for newly established businesses to secure funding beyond an owner's personal resources because a credit history is usually required as a prerequisite to obtaining a loan or credit line. The transactions between a business and a vendor over a sufficient length of time, for example, provides a credit history; this type of information allows a credit bureau/agency to calculate a credit score or rating. The credit bureau/agency will look at a business' payment history, the severity of any delinquencies, and any non-payments as factors in determining a score. It is this score that is examined when businesses wish to establish credit lines with vendors since the credit score correlates with a business' ability to pay.

Unfortunately for many new businesses, a credit history is nonexistent and a credit score cannot be obtained without using one's own personal savings or without the support of seed money provided by angel investors. Should a business owner lack sufficient personal funds or such investors, it becomes difficult if not impossible to commence business operations. Hence, a problem arises when it comes to securing funding for many start-up businesses.

There are some businesses that have a history of undesirable credit. These businesses may seek to improve their credit score so that they may be able to secure funding from lenders. When a score falls within an unsatisfactory range, it becomes difficult for a business to secure the desired amount of funding from financial institutions. When funds are offered by a lender, the cost of borrowing such funds and other origination fees may be highly prohibitive.

Another important factor in the growth of a business is its perception to other businesses and consumers. Business partnering and affiliations are more readily established with other businesses having a strong financial track record. It is often seen that most companies tend to affiliate with other companies having at least a financial reputation as strong as their own. Successful businesses tend to partner with like companies in an effort to synergistically enhance their sales and ultimately enhance their financial records. Furthermore, consumers will often tend to purchase products and services associated with companies they perceive to have a strong financial rating. Often than not, a consumer will purchase merchandise based on his perception of a company's financial strength and future existence since the ability to receive follow-up customer service and product warranties are a component of a product's overall value. As a consequence, it is important for a business to be able to establish a strong credit score or rating. This, however, is difficult for many struggling and most start-up businesses.

Finally, a significant aspect in the perspective of a business owner, is his ability to secure funding at the lowest cost possible. A lender will look at a business' ability to repay a loan. The lender will seek to investigate the business' credit history which is summarized in a business' credit score or rating. The lender will capture this repayment risk in the form of interest charged to the borrower. The interest rate charged to the borrower will be proportional to the risk perceived by the lender. The business owner will seek to obtain the most desirable credit score in order to secure the lowest interest rate possible. Often the interest charged may have a significant impact on whether a business can survive in its first few years of operation. As a result, the interest rate of a loan may have a significant impact in the cashflow, profitability, and survival of a business.

Unfortunately, the process by which a credit score may be obtained is fraught with pitfalls. Many of these pitfalls will result in a business not obtaining a score, or will result in the business being assigned a low credit score. A method and system for obtaining a business score for a business or improving existing undesirably low score, is desired. Preferably, this method overcomes the above-referenced pitfalls and facilitates the business obtaining a high credit score.

### SUMMARY OF THE INVENTION

The invention comprises a method for establishing or enhancing a business credit score. A business credit score is generated from information obtained from a business' payment experiences or transaction history. The business credit score is reported from well known credit agencies/bureaus. Establishing desirable credit score(s) are important to businesses because the score(s) are used by lenders (i.e., financial institutions) to qualify a borrower's risk of repayment. If the risk of repayment is high, a lender may choose not to provide funding to the business. In cases where funding is offered to a business, the cost of capital may be high and attaining a higher credit score may be desirable.

In one embodiment, a method includes the step of verifying the existence of any business credit score(s) provided by well known credit agencies/bureaus. In the absence of a credit score, in one step information is obtained regarding the business and that information is used to determine if any other entities are using the same information. If so, then steps are taken to ensure that the business and the other entity do not use the same information. In one embodiment, this step comprises examining records, such as Secretary of State and other public records to determine if other entities have one or more of the same named officers or identify the same telephone number and/or address as the business. In the event other entities are using the same telephone number and/or address or identify the same officers, steps are taken to ensure that the business has an independent phone number and address and that the common officers are eliminated.

In the case where a business has already been assigned one or more credit scores, the method includes the step of assessing the score(s) in terms of the business owner's financial requirements. The business credit score and supporting information provided by the credit agency/bureau is analyzed for accuracy and any corrective measures are taken. Corrective measure may also include the above-referenced verification step. After the information has been corrected, a new score that is preferably higher, is generated from the credit agency/bureau.

In one embodiment, the method of the invention also includes the step of compiling a list of vendors. In a preferred embodiment, the vendors which are compiled meet one or more criteria, including providing credit without a personal guarantee and routinely reporting credit/payment events to credit agencies for purpose of generating credit scores. In one embodiment, the vendors are categorized based upon the goods and/or services which the vendors offer.

The method includes the step of permitting a business to access the list of vendors to identify vendors with whom they can and wish to engage in transactions which will result in reporting to the credit agency. The method also includes the step of facilitating these transactions, including the steps of providing identification information, such as contact information, for each vendor to the business.

After facilitating credit and/or payment transactions between the vendor(s) and the business, a series of payment experiences are reported to well known credit agencies/bureaus. These payment experiences, which are preferably favorable experiences of timely payment, coupled with accurate business information are expected to result in the establishment of a high business credit score or credit rating from these credit agencies/bureaus for the business.

In one embodiment, the method further includes the steps of obtaining credit cards or other forms of credit which is normally unavailable without a credit rating. In one embodiment, once a credit rating is obtained, a business accesses a list of companies that issue credit cards or lines of credit and engage in transactions with one or more of them. The list of companies preferably includes companies which meet predetermined criteria for issuing credit cards or similar lines of credit, such as the issuance of such without a personal guarantee. After facilitating transactions with the one or more companies, additional credit is obtained, and a higher credit rating may be established.

In accordance with the invention, a simplified method of facilitating a business obtaining a credit score or enhancing a credit score is provided. The method eliminates or avoids pitfalls, which often result in a low credit score. In addition, the method facilitates the business in obtaining lines of credit and desired goods and services from vendors upon favorable terms.

Further objects, features, and advantages of the present invention over the prior art will become apparent from the detailed descriptions which follows, when considered with the attached figures.

### DESCRIPTION OF THE DRAWINGS

FIG. 1 is a flow diagram illustrating a method of the invention;

FIG. 2 is a flow diagram illustrating an embodiment of steps of a method of the invention for facilitating generation of a credit score or improves an existing credit score; and

FIG. 3 is a flow diagram illustrating an embodiment of steps of a method of the invention for facilitating obtaining of credit lines, such as credit cards.

### DETAILED DESCRIPTION OF THE INVENTION

The invention is a method of establishing or improving a credit score of a business, thereby enhancing its ability to secure funding and to establish credit lines from financial institutions such as banks, loan companies, and the like. The invention comprises methods of establishing or improving a business' credit score generated by well known credit agencies/bureaus. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The present invention comprises a method of establishing or improving a credit score of a business as generated by well known credit agencies/bureaus. Given a start-up business' need to secure credit quickly, the invention provides a method to efficiently generate the highest score possible over a short period of time. In general, a business' ability to secure funds and generate loans is highly based on this credit score because a lender will base his decision to fund a business based on this score. The score provides a numerical assessment of a business' payment experiences. Examples of credit agencies/bureaus are companies such as Dunn & Bradstreet and Experian. These credit bureaus are exemplary, and there may be other credit agencies/bureaus that provide similar credit scores. Dunn & Bradstreet (D&B) for example, generates a PAYDEX score that utilizes a scale from 0-100, where a higher number corresponds to a lower credit risk. In addition, D&B generates an additional figure of merit called a DUNS rating. A DUNS rating may incorporate factors such as account payment history, employee size, public records information, and a business' financial statements. On the other hand, Experian generates an INTELLISCORE score that also utilizes a scale from 0-100, in which a higher number corresponds to a lower credit risk. Lenders typically analyze these scores which may be included in a business report provided by a credit agency/bureau. For example, a D&B business report may comprise a PAYDEX score, a DUNS rating, payment experiences for the business, and various public information records.

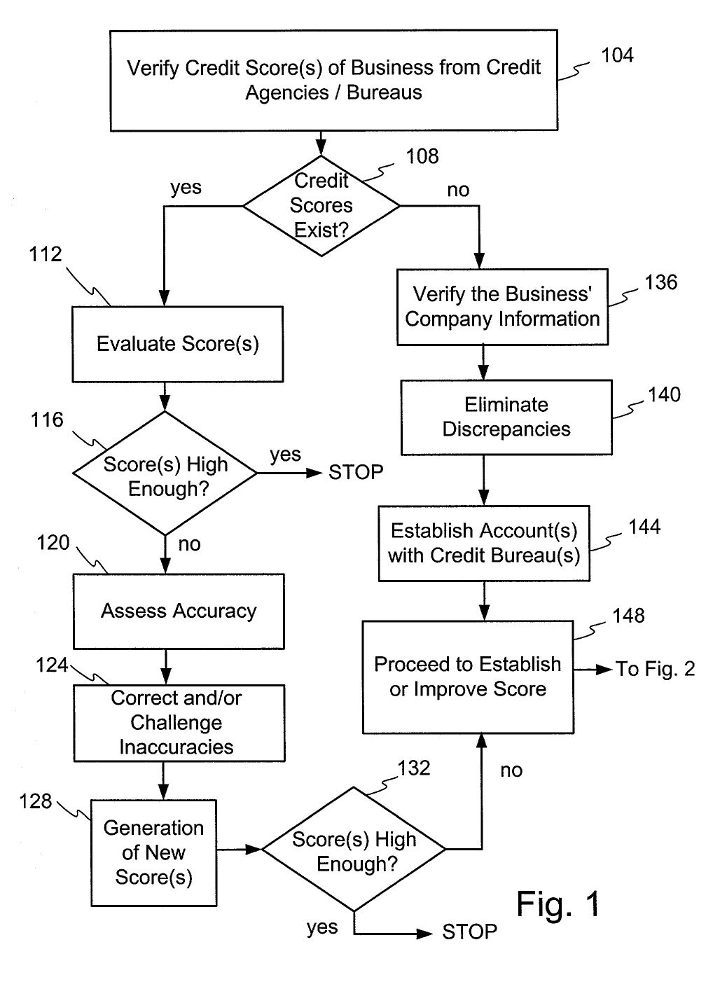

FIG. 1 illustrates an operational flowchart of one embodiment of a method in accordance with the invention. The method shown can be employed by a business to establish or improve its credit score. The method and embodiment represented by the steps shown in FIG. 1 is typically performed by a third party or “service provider” acting as a facilitator to the business or “customer” seeking to establish or improve its credit score/rating, although the business itself may employ such methods on its own.

In steps 104 and 108, the process begins by verifying whether a credit score exists from well known credit agencies/bureaus such as D&B and Experian. Should a credit score exist for the business, an evaluation of the score(s) is made. Upon score evaluation, a decision is made by the business owner concerning the adequacy of the score(s), as shown in step 116. If the score(s) are adequate, the process terminates here. For example, a small loan amount may readily be approved by a lender given a particular credit score as compared to a large loan amount.

If a score is determined as inadequate for the business' purposes, an assessment is made to determine its accuracy as shown in step 120. Should there be any discrepancies regarding a particular payment transaction contributory to causing a low score, the credit agency may be notified of the inaccuracy. This is typically accomplished by having the appropriate vendor provide supporting documentation regarding the corrected transaction. This step is shown in step 124.

After all inaccuracies have been corrected, a new score may be generated from the appropriate credit agency/bureau as shown in step 128. For example, a request may be made by the business owner through a subscribed service provided by the appropriate credit agency/bureau in which credit score queries can be made by a subscriber over an automated phone system or via an Internet based computer network.

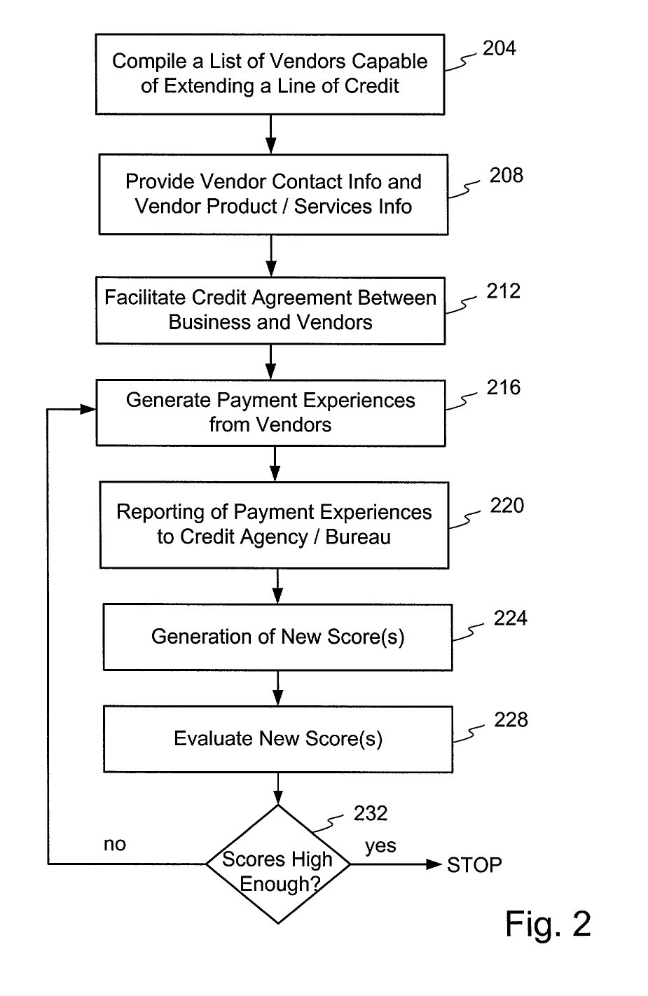

Thereafter, in step 132, the new score is obtained and a decision is made regarding whether the score is adequate. Should the score be adequate for the business owner's purposes, the process may be terminated. Otherwise, the process preferably proceeds to FIG. 2, as shown in step 148, in order to improve the business' payment transaction history, and more particularly, its credit score or rating.

If in step 108, it is determined that no credit score exists for the business, the method of the invention comprises steps for obtaining a credit score. In one embodiment, the process proceeds, as shown in step 136, by verifying or determining certain information regarding the business. This information may comprise, for example, the names of all officers, the address, telephone number and/or other information identifying the business or associated with the business. This information may be obtained from the business and/or a check of public records.

In step 140, the process proceeds by eliminating discrepancies, such as common references. In one embodiment, this step includes the step of determining if any other entities are utilizing any of the same information as the business. If one or more other entities are using the same information, then in accordance with the invention the method proceeds with the elimination of the commonly used information. In another embodiment, if the one or more other entities are using the same information and the one or more other entities have a negative credit reference, rating or treatment, then the commonly used information is eliminated.

In one embodiment, this step includes determining if any of the officers of the business are identified as officers of other businesses. In one embodiment, in the event the officers of the business are the same identified officers of other companies or businesses, then steps are taken so this is no longer the case. For example, this may comprise a party resigning as an officer of the other entity or business.

In another embodiment, in the event the officers are identified as officers of other businesses, those businesses are investigated. If those other businesses have poor credit ratings or other negative treatment, then additional steps may be taken to either disassociate the officer from those businesses or improve the rating or treatment of that business to ensure that the low rating or negative treatment does not inure to the business as a result of the officer being an officer of both corporations.

As indicated, this step of determining of the officers of the business are the same as one or more other entities may include the step of searching the records of the Secretary of State or other registrar of corporate and other business information of the state where the business is located/incorporated to determine if other entities have the same identified officers.

In one embodiment, the step of eliminating discrepancies may also comprise or include determining if the address and/or phone number for the business are the same as the address and/or phone number of another business to avoid a negative result, which may occur when the business seeks its credit score. Thus, as one step, if such occurs, the commonly used information is eliminated. In one embodiment, this may comprise the step of the business seeking a new address and/or phone number which is unique from other businesses or erroneous information (such as another business wrongly identified as having the same phone number) is corrected. This step may comprise searching a variety of business information, including business license listings, Secretary of State corporate information, the telephone book and other sources.

In accordance with the method, other information may be corrected. Discrepancies or errors in information may cause significant difficulties in obtaining a credit score from well known credit agencies/bureaus. For example, these discrepancies may put a business in a “high risk” rating, preventing a business from establishing a credit score. Therefore, these discrepancies are resolved and/or eliminated prior to engaging in the process of generating a credit score. In the case where a discrepancy is caused by an inaccuracy, the discrepancy may be removed by providing supporting documentation to the appropriate public records agency and by subsequently verifying that corrective changes were made.

Next, the process proceeds to step 144. In accordance with this step, an account is established at or with a credit agency/bureau, as typified by establishing a D & B DUNS number. The process then proceeds to FIG. 2, as shown in step 148, in order to a establish a score by generation of payment transaction history.

FIG. 2 illustrates an embodiment of a method to facilitate obtaining a score by either creating a payment transaction history for a start-up business or improving a payment transaction history for a business wishing to improve its credit score. It may be utilized as a continuation of the method shown in FIG. 1, represented by the succession of step 148. The method and embodiment represented by the steps shown in FIG. 2 is typically facilitated by a third party acting as a consultant to the business seeking to establish or improve its credit score/rating, although the business itself may employ such methods on its own.

In step 204, the process starts by providing to the business a list of vendors for use in reporting credit-worthiness information to the entity which establishes the business credit score. In one embodiment, this step includes the step of compiling a list of vendors which satisfy one or more criteria. These criteria may vary, and the step of compiling the list and determining a particular vendor meets or continues to satisfy the criteria may be determined by the third party provider.

In one embodiment, a first desired criteria is that the vendor extend a credit line to a business without requiring a personal guarantee to secure the credit line. Another criteria is that the vendor regularly report all payment experiences for all businesses to which it extends a credit line. This allows the business to generate a payment history without requiring cash. Depending on the situation, it is contemplated that some vendors in the list may require a portion of a purchase transaction in cash.

In one preferred embodiment of the invention, the vendors may be arranged by category of products and services it offers, thereby allowing the business to recognize vendors suitable for its future purchase requirements. In one embodiment, this step includes the step of seeking vendors which provide products and/or services of a variety of types and which meet the desired criteria, and then categorizing the vendors by their products and/or services.

In step 208, vendor contact information and information such as the types of products/services it offers is provided to the business owner. In one embodiment, the vendor list and/or specific information regarding a vendor may be provided by printed document or by telephone. In a preferred embodiment, the vendor information is provided in computer readable form. In this embodiment, a diskette or other means for storing computer readable information may be provided to the business for reading by their computer. The computer display the information for access and viewing by the business.

In another embodiment, the information is provided in computer readable form from a remote computer to a computer of the business via a communication link such as provided through a dial-up, cable, or digital subscriber line access connection with end-to-end transmission over a media such as the Internet. In one embodiment, a computing device of the service provider acts as an information server and database repository of vendor information relevant in facilitating development of a credit line between the business and the vendor.

In one embodiment, the vendor information may be stored at the server computer as an accessible file or be displayed as an HTML web-browser displayable file. In one embodiment, access to the information, such as a displayable webpage or a download of a particular file, may be limited. In such an embodiment, access to the information may only be permitted through a security login process requiring the input of a password or other identification information. The server computer system may invoke a software program within its memory to automate the process of communicating such relevant information to authorized clients. The computer system and software may facilitate a categorization of the list of vendors by products and services offered or by some other criteria. The computer system and software may also control one's access to available services and features based on the profile of the user.

The computer system may also facilitate the completion of vendor agreements, application forms, and the like. These forms may be capable of being filled out and processed by the business owner over a secure connection that utilizes any transmission media, such as the Internet. In one embodiment, it is contemplated the computer system and software may transmit the completed forms to the appropriate vendor(s) while the user client is on-line over the Internet. Additional document transmission methods may comprise the use of e-mail, fax, courier, or regular mail.

The vendor list comprises vendors capable of extending a credit line such that a number of purchase transactions can be made by the business within a minimum amount of time, allowing new payment transaction data to be reported to a credit agency, and as a result, allowing the development of a new business credit profile and a new credit score.

In step 212, it is contemplated that the business engage multiple vendors to provide a sufficient number of transaction experiences from different vendors which will cause the credit agency/bureau to issue a credit score. In one embodiment, this number of vendors is three. Thereafter, the business engages in a number of purchase and associated payment transactions to these new vendors, as indicated in step 216. It is contemplated that the resulting transactions comprise only desirable payment experiences, such as payments that are considered to be made on-time. This allows an accumulation of new data that can be used by the credit agency to formulate a new credit score.

In step 220, the selected vendors with whom the business engages in one or more transactions report the resulting payment transaction data to the appropriate credit agencies/bureaus. The process of securing additional vendor relationships and accumulating transaction experience data continues to occur until it is estimated or determined that the reported data will generate an adequate credit score for the business.

In one embodiment, the service provider or business/customer may cause the vendor to report the transaction. In a preferred embodiment of the invention, the vendor may be removed from the vendor list in the event that the vendor does not report data. In this manner, the vendor has incentive to actively report transactions. Other means may be utilized to facilitate the reporting of the information.

At this point in time, as indicated in step 224, a new credit score is generated from the credit agency. Such a request may be made by the business owner through a subscribed service provided by the appropriate credit agency/bureau in which credit score queries can be made by a subscriber over the Internet.

At step 228, upon receiving and evaluating the new score(s), a decision is made in step 232 concerning whether the score is adequate for the business owner's financial requirements. If the score is adequate, the process terminates. However, if the score is inadequate, the process loops back to step 216 to allow additional payment experiences to be generated until an adequate score is attained.

Note that the method described in FIG. 2 may be the same for start-up businesses as well as established businesses; however, it is contemplated that an established business owner requiring a higher credit score may be provided with an evaluation and analysis concerning any history of undesirable payments in order to insure that preferable payment transaction experiences are generated in the future. It is contemplated that the analysis may, for example, incorporate facilitating changes in the business' practices or procedures, so as to mitigate the possibility of undesirable payment transactions in the future. It is contemplated that such changes may be performed prior to the business engaging in any purchases from the selected vendors.

In addition, steps 136-144 may also be performed with respect to a business already having a score. In particular, if the business has been assigned a low score, these steps may be useful in facilitating the business' obtaining of a better credit score.

Although the method and embodiment represented by the steps shown in FIG. 2 may be most effectively performed by the third party business or service provider acting as a facilitator to a business seeking to establish or improve a credit score/rating, it is contemplated that the business seeking to establish or improve its credit score/rating may itself engage in establishing credit lines with its own vendors and may utilize the method and embodiment represented by steps 204 through 232. In such event, step 204 may comprise the business identifying one or more vendors with which the business desires to conduct transactions, and then contacting those one or more vendors and engaging in transactions with them.

As described in the embodiment of FIG. 2, a method is described to facilitate generation of a business credit score from a well known credit agency/bureau such as Dunn & Bradstreet and Experian. The method of utilizing a vendor list provided by a third party facilitator allows a credit score to be established quickly for a new business. The method also allows for the improvement of a credit score for an existing business. An element of this method comprises the use of vendors providing reliable reporting of all payment experiences to well known credit agencies/bureaus. In addition, an element of this method comprises vendors that do not require a personal guarantee in its extension of credit to a business. Furthermore, an element of this method comprises supplying a list of vendors that may be categorized by various criteria such as the products and services that it offers, facilitating efficient vendor selection for the business owner.

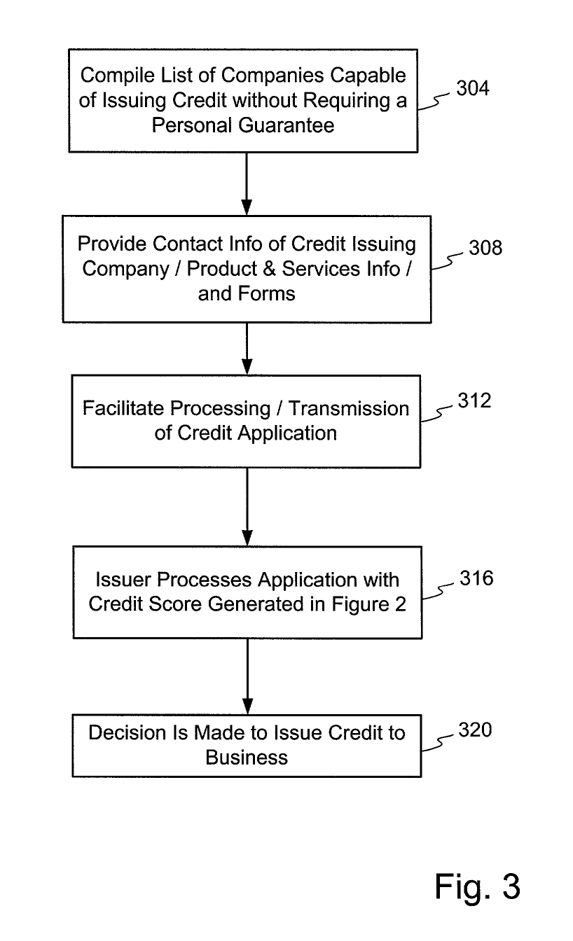

FIG. 3 illustrates one embodiment of a method for facilitating receiving credit cards and/or other lines of credit which are often difficult to obtain without a business first having been assigned a satisfactory credit score. In one embodiment, the method is directed to providing a business with credit from retail businesses that do not require a personal guarantee in the application process. The method and embodiment represented by the steps shown in FIG. 3 is typically performed by a third party acting as a facilitator to the business seeking to obtain the credit cards or other lines of credit.

In step 304, the process starts by providing to the business a list of companies which issue credit cards or other forms of credit. In a preferred embodiment, this list of companies or entities differs from the vendor list detailed above in that these companies or entities will not provide credit without the business first having a credit rating.

This step may include the step of the service provider compiling a list of such companies. In a preferred embodiment, these credit card or other credit issuing companies satisfy a plurality of criteria. One such criteria is preferably that the company does not require a personal guarantee in their credit card application process.

In step 308, the third party facilitator provides contact information for the one or more companies or entities, product/service information, and/or documentation such as credit card agreements and application forms to the business owner. As indicated earlier, the forms may be generated by a remote computer system similar to that described in FIG. 2, capable of transmitting data securely over the Internet, and providing the business client the convenience of logging in with a password and being able to select various services and features he is entitled to. It is contemplated the computer system may hold a database of credit card issuing companies categorized by type of product/services offered, geographic location, or some other criteria.

As shown in step 312, it is contemplated the credit agreement/application may be processed on-line over the Internet as a convenience to the business owner. Additional document transmission methods may include e-mail, fax, courier, or regular mail.

Thereafter, in step 316, it is contemplated that the credit score of the business (as may be generated by the method described in FIG. 2) is reviewed by the company along with the application. In this embodiment, the generation or improvement of a credit score (as described in FIG. 2) occurs prior to the described credit card application process, such that the credit score is available for review by the company issuing the credit card. It is contemplated that many credit card issuing companies will require a business credit score prior to approving a credit card application.

Finally, in step 320, a decision is made by the company regarding whether to extend credit, such as via issuance of a credit card It is contemplated that the method described previously in FIG. 2 is employed by the business to insure the issuance of credit, such as by credit cards, and to maximize the credit limits provided by each credit line or card.

The methods of the invention may be implemented in a variety of manners. As indicated above, various of the methods or the steps thereof may be implement by a system, such as a system including one or more computing devices.

One embodiment of the invention comprises a system for facilitating a business in obtaining a credit score or improving a credit score. In one embodiment, the system includes at least one computing device. As indicated above, this computing device may comprise a server to and from which information may be transmitted over a communication link. In one embodiment, the server or other computing device includes a data storage device. This data storage device may comprise a memory device, such as RAM or ROM, a hard disk drive or the like.

The system also includes data. In one embodiment, the data comprises one or more files having vendor data associated therewith. As indicated, the vendor data may include vendor identification information, such as vendor name and contact information. The vendor data may also include information regarding the category or categories of products/services which the vendor offers. Preferably, the data comprises information regarding one or more vendors which meet particular criteria. As described above, those criteria may vary.

In one embodiment, the data also comprises one or more files having credit card company data associated therewith. As indicated, the credit card or other credit issuing company data may include company identification information, including name and contact information. The data may also include information regarding the types of credit which the company offers.

The methods and systems of the invention have a number of advantages. A particular advantage of the invention is that a method is provided for efficiently establishing or improving a credit score/rating issued by well known credit agencies/bureaus. The method contributes to a business obtaining a credit score, and most preferably, the highest possible score, with minimal effort.

First, pitfalls associated with incorrect business information or business information which may cause a low score or no score to be issued are avoided. In accordance with the method, particular steps are taken to ensure that the business information is analyzed and steps taken to ensure that the information will not negatively affect the ability to obtain a credit score or the highest credit score.

In the normal course of business, a business contacts many vendors seeking vendors which will provide goods and/or services on acceptable terms. This is very time consuming. Further, in many situations, a new business can not find a vendor which will supply the goods and/or services which they desire without a personal guarantee. In accordance with the invention, the business need only select from a predefined list of vendors to find vendors providing the desired goods and services upon favorable or desirable terms.

Lastly, transactions with the vendors is facilitated and reporting of the transactions with those vendors is assured. Often, businesses engage in transactions with many vendors which never report transaction information, and thus never has sufficient information reported in order for a credit rating to be generated. In accordance with the invention, the business is directed to vendors who report their transactions. In accordance with the invention, a method is provided for a business to engage a minimum number of vendors which will cause the credit agency to generate a credit rating. Again, this avoids substantial time and expense on behalf of the business.

Another aspect of the invention is that the method may be utilized to cause a credit score to be generated and assigned to a business which then enables the business to obtain otherwise unavailable credit. This credit may comprise credit cards or credit lines. In one embodiment, a business having a credit score may utilize a list of companies or entities which provide credit, such as by credit cards, in order to increase their score and obtain more credit.

A side benefit to one aspect of the method is that vendors which seek additional business may comply with the terms and conditions for being placed on the vendor list. These vendors are then exposed to new businesses seeking to engage in transactions. In this manner, the businesses are exposed to vendors who provide the goods and services they desire on favorable terms, and the vendors obtain new clients.

The methods of the invention may be implemented in a variety of fashions. In one embodiment, a third party provider centrally performs various of the steps of the method, including compiling the list of vendors. The third party provider can then facilitate the method for a plurality of businesses, enabling many businesses to obtain a favorable credit score. In other embodiments, a business itself may engage in the steps in order to obtain its own score.

In one embodiment, various aspects of the invention may be implement via a system. This system may comprise a computer network, such as computers communicating over the Internet. In this manner, a third party business may provide vendor and related information to various businesses, and those businesses may readily access the data. Other aspects of the invention may be implemented via the network, speeding the process.

It will be understood that the above described arrangements of methods therefrom are merely illustrative of applications of the principles of this invention and many other embodiments and modifications may be made without departing from the spirit and scope of the invention as defined in the claims.

What is claimed is:

1. A method of facilitating the establishment of a credit rating for a business comprising the steps of:
verifying that a credit rating does not exist with a credit agency;
determining information regarding said business;
searching public records information to determine the existence of other entities using said business information;
eliminating associations with other identified entities;
facilitating creation of an account with a credit agency/bureau to generate a credit rating/score;
identifying to said business a plurality of vendors capable of extending a credit line; and
permitting said business to engage in transactions with a number of said plurality of vendors to generate payment experiences;
whereby when said vendors report said payment experiences to said credit agency after completion of said transactions and said credit agency generates and reports a credit score to said business.

2. The method in accordance with claim 1 wherein said identify step includes the step of providing vendor identification information.

3. The method in accordance with claim 1 including the step of compiling a list of said vendors.

4. The method in accordance with claim 3 wherein said vendors comprise vendors that do not require a personal guarantee and consistently report payment experiences to said credit agency.

5. The method in accordance with claim 3 including the step of categorizing said vendors based upon the type of products and services offered by said vendors.

6. The method in accordance with claim 1 including the step of providing agreements and application forms to facilitate said step of said business engaging in transactions.

7. The method in accordance with claim 1 wherein said step of determining information regarding said business comprises identifying information regarding the business selected from the group consisting of: names of officers, telephone number and address.

8. The method in accordance with claim 1 wherein said step of searching comprises searching for businesses having one or more of the same named officers, the same telephone number or the same address.

9. The method in accordance with claim 1 wherein said step of eliminating associations comprises causing said business and said other identified entity to have different telephone numbers, addresses and officers.

10. The method in accordance with claim 1, wherein said credit agency comprises Dunn & Bradstreet or Experian.

11. The method in accordance with claim 1 wherein said credit rating comprises a Dunn & Bradstreet PAYDEX score, an Experian INTELLISCORE score, or Dunn & Bradstreet DUNS score.

12. A method of facilitating the improvement of a credit rating for a business comprising the steps of:
verifying the credit score generated by at least one credit agency for said business;
facilitating changes in business practices of said business to minimize undesirable credit based transactions to vendors prior to engaging in any future said credit based transactions;
generating a list of vendors capable of extending a credit line;
facilitating a number of transactions with a number of said vendors to generate payment experiences; and
facilitating said business to request a credit rating from said credit agency after said facilitating a number of transactions with a number of said vendors has occurred wherein transaction experiences have been reported to said credit agency.

13. The method in accordance with claim 12 wherein said generating step includes the step of identifying contact information of said vendors.

14. The method in accordance with claim 13 wherein said generating step comprises generating a list of vendors that do not require a personal guarantee and consistently report payment experiences to credit agencies.

15. The method in accordance with claim 12 including the step of categorizing said vendors by the type of products and services offered by said vendor.

16. The method in accordance with claim 12 including the step of providing agreements and application forms to facilitate the application process to facilitate said transactions between said business and said vendors.

17. The method in accordance with claim 12 wherein after said business obtains a credit score said method includes the steps of generating a list of entities issuing credit cards; providing said business access to said business; and facilitating said business in obtaining credit cards from one or more of said entities.

18. A system for providing information for use by a business in establishing a credit rating comprising:
a remote computer system for receiving and transmitting information;
a data storage device associated with said remote computer system;
information stored at said data storage device representing a list of vendors arranged by vendor category;
user information stored at said remote computer system;
a communication interface permitting communication between said remote computer system and a user computer; and
a user verifier for verifying the identity of a user using said user information and providing access to said vendor information.

19. The system in accordance with claim 18 wherein said list of vendors comprises a list of vendors which provide credit without a personal guarantee.

20. The system in accordance with claim 18 wherein said vendor information is stored in the form of an HTML file.
